(19) United States
(12) Patent Application Publication
(10) Pub. No.: US 2024/0351315 A1
(43) Pub. Date: Oct. 24, 2024

(54) MOISTURE BARRIER CARRIER TAPE AND LID FOR ELECTRONIC PARTS

(71) Applicant: HONEYWELL INTERNATIONAL INC., CHARLOTTE, NC (US)

(72) Inventors: FEI QIAO, SHANGHAI (CN); XIAODONG PAN, SHANGHAI (CN)

(73) Assignee: HONEYWELL INTERNATIONAL INC., CHARLOTTE, NC (US)

(21) Appl. No.: 18/612,897

(22) Filed: Mar. 21, 2024

Related U.S. Application Data
(60) Provisional application No. 63/497,300, filed on Apr. 20, 2023.

(51) Int. Cl. B32B 27/08; B32B 7/12; B32B 27/32

(52) U.S. Cl. CPC B32B 27/08; B32B 7/12; B32B 27/322; B32B 2250/05; B32B 2250/24; B32B 2323/04; B32B 2325/00; B32B 2327/12; B32B 2457/00

(57) ABSTRACT

Multilayer packages are provided for packaging products, such as components of electronic devices are provided, and are particularly well suited for the fabrication of carrier tapes. The packages include a container component and at least one cover component, each of which incorporate a layer of a fluoropolymer (fluorine-containing polymer). A multilayer container film is shaped to include pockets extending from one or both planar surfaces and exhibits excellent barrier properties and structural strength.

### CROSS-REFERENCE TO RELATED APPLICATION

This application claims the benefit of co-pending U.S. Provisional Application Ser. No. 63/497,300, filed on Apr. 20, 2023, the disclosure of which is incorporated by reference herein in its entirety.

### BACKGROUND

### Technical Field

The present disclosure generally relates to multilayer articles for packaging products, such as components of electronic devices.

### DESCRIPTION OF THE RELATED ART

Carrier tape is a product commonly used in the electronic packaging industry for the packaging of small electronic components, such as integrated circuits, capacitors, connectors, etc., and for their protection during shipping and storage. A typical carrier tape is formed from a multilayer film that is embossed, punched or otherwise shaped to include a plurality of sequential pockets (recesses) along the axial length of the tape for storage of the products. The carrier tape is then sealed with a lidding film to enclose the stored products within the pockets, and the tape is typically then wound up and stored on a reel, allowing the parts to be conveyed in large quantities without being damaged. For downstream processing by electronics manufacturers, specially designed machines are engineered to peel off the lidding film and individually remove the stored electronic devices from the pockets in an automated assembly line.

Similar to when storing pharmaceuticals, it is very important that storage solutions for electronic components have good barrier properties, including barriers to gas, aroma, and/or vapor such as water vapor, as well as physical characteristics, such as toughness, clarity, wear and weathering resistances, light-transmittance and chemical inertness. For example, it is known that very small electronic parts that are used in manufacturing printed circuit boards (PCBs) are prone to absorbing atmospheric moisture, and components having retained moisture will cause problems when they are welded to the boards. Therefore, when manufacturing PCBs, it is typical for the components to be dried in an oven for several hours before being mounted on the board. That additional drying step is time consuming, inefficient, costly, and therefore is a problem in the art.

Like in the pharmaceutical packaging industry, it is known that carrier tapes can be made from multilayer films having the desired barrier properties. Typically, embossed or punched carrier tapes are mainly composed of polymers such as polycarbonate, polystyrene and acrylonitrile butadiene styrene (ABS) copolymers. However, it is not commonly known to incorporate fluoropolymers in carrier tape constructions. In the pharmaceutical packaging industry, it has been desirable to use or incorporate fluoropolymer films in packaging applications as they are known for their barrier properties, inertness to most chemicals, resistance to high temperatures, low coefficients of friction and excellent toughness. See, for example, U.S. Pat. Nos. 4,146,521; 4,659,625; 4,677,017; 5,139,878; 5,855,977; 6,096,428; 6,138,830; and 6,197,393, which teach multilayer fluoropolymer-containing films. Films comprising polychlorotrifluoroethylene (“PCTFE”) homopolymers or copolymers are particularly advantageous due to their excellent properties. However, such use of fluoropolymers is restricted to specialty packaging applications due to their relatively high cost. A suitable means of reducing the cost of a packaging material fabricated from a costly polymer is to form multilayer structures in which the polymer is laminated with other, less costly polymer layers. This approach is particularly desirable for the fluoropolymer packaging applications since a thin layer of the fluoropolymer is often all that is needed to take advantage of the desirable properties of the fluoropolymer while minimizing the cost. However, fluoropolymers do not adhere strongly to most other polymers. In fact, most fluoropolymers are known for their non-stick characteristics. This is very disadvantageous, because poor bond strength between layers can result in the delamination of multilayer structures.

To improve the bond strength between a layer of a fluoropolymer and a layer of a non-fluoropolymer polymer layer, an adhesive layer may be used between adjacent layers. For example, U.S. Pat. No. 4,677,017 discloses coextruded multilayer films which include at least one fluoropolymer film and at least one thermoplastic film which are joined by the use of an ethylene/vinyl acetate adhesive layer. U.S. Pat. No. 4,659,625 discloses a fluoropolymer multilayer film structure which utilizes a vinyl acetate polymer adhesive layer. U.S. Pat. No. 5,139,878, discloses a fluoropolymer film structure using an adhesive layer of modified polyolefins. U.S. Pat. No. 6,451,925 teaches a laminate of a fluoropolymer layer and a non-fluoropolymer layer using an adhesive layer which is a blend of an aliphatic polyamide and a fluorine-containing graft polymer. Additionally, U.S. Pat. No. 5,855,977 teaches applying an aliphatic di- or polyamine to one or more surfaces of a fluoropolymer or non-fluoropolymer material layer.

However, packaging solutions such as those described above that are well-suited for the pharmaceutical packaging industry are not sufficiently moisture-resistant to meet the needs of the electronics packaging industry, particularly when packaging tiny electronic parts in a carrier tape. The present disclosure provides a solution to this need in the art.

### SUMMARY OF THE DISCLOSURE

This disclosure is particularly directed to packaging articles including both a container portion and a lid portion, where both the container and lid portions are multilayer films that include a fluoropolymer layer or fluorine-containing polymer layer. It is particularly useful for the fabrication of carrier tapes for packaging small electronic components used in electronic devices such as cell phones and precision equipment. The packaging solution of this disclosure overcomes the need to dry parts in an oven prior to use, thereby prolonging the shelf life of the parts and improving production efficiency.

More particularly, the disclosure provides a package comprising:
a) a shaped container comprising a multilayer film, the container comprising one or more pockets, said container having a top surface and a bottom surface, the multilayer film comprising:
   i. a first base layer;
   ii. first intermediate adhesive layer;
   iii. a first fluoropolymer layer adhered to the first base layer via the first intermediate adhesive layer;
   iv. a second intermediate adhesive layer; and
   v. a second base layer adhered to the first fluoropolymer layer via the second intermediate adhesive layer;
b) a top cover adhered to the top surface of the container, the top cover comprising:
   i. a first heat seal layer attached to the first base layer;
   ii. a third intermediate adhesive layer; and
   iii. a second fluoropolymer layer adhered to the first heat seal layer via the third intermediate adhesive layer.

Also provided is a packaged product comprising:
a) a shaped container comprising a multilayer film, the container comprising one or more pockets, said container having a top surface and a bottom surface, the multilayer film comprising:
   i. a first base layer;
   ii. first intermediate adhesive layer;
   iii. a first fluoropolymer layer adhered to the first base layer via the first intermediate adhesive layer;
   iv. a second intermediate adhesive layer; and
   v. a second base layer adhered to the first fluoropolymer layer via the second intermediate adhesive layer;
b) a product contained within one or more of said pockets;
c) a top cover adhered to the top surface of the container, the top cover comprising:
   i. a first heat seal layer attached to the first base layer;
   ii. a third intermediate adhesive layer; and
   iii. a second fluoropolymer layer adhered to the first heat seal layer via the third intermediate adhesive layer;
      and optionally,
d) a bottom cover adhered to the bottom surface of the container, the bottom cover comprising:
   i. a second heat seal layer attached to the second base layer;
   ii. a fifth intermediate adhesive layer; and
   iii. a third fluoropolymer layer adhered to the second heat seal layer via the fifth intermediate adhesive layer.

Still further provided is a process for forming a carrier tape useful for storing a plurality of products, the process comprising:
a) forming a multilayer film comprising:
   i. a first base layer;
   ii. first intermediate adhesive layer;
   iii. a first fluoropolymer layer adhered to the first base layer via the first intermediate adhesive layer;
   iv. a second intermediate adhesive layer; and
   v. a second base layer adhered to the first fluoropolymer layer via the second intermediate adhesive layer;
b) embossing the multilayer film to thereby form a shaped container that comprises one or more pockets, said container having a top surface and a bottom surface;
c) placing a product into one or more of said pockets; and
d) heat sealing a top cover to the top surface of the container, which top cover comprises:
   i. a first heat seal layer;
   ii. a third intermediate adhesive layer; and
   iii. a second fluoropolymer layer adhered to the first heat seal layer via the third intermediate adhesive layer;
   wherein the first heat seal layer is attached to the first base layer.

### BRIEF DESCRIPTION OF THE DRAWINGS

FIG. 1 is a schematic representation, side perspective view, of a package of the disclosure showing the layering structure of a container with a shaped pocket and a top cover enclosing a product in the pocket.

FIG. 2 is a schematic representation, side perspective view, of a carrier tape of the disclosure showing the layering structure of a container with multiple shaped pockets and both a top cover and a bottom cover enclosing products in pockets.

FIG. 3 is a schematic representation, top perspective view, of a carrier tape including inspection holes in the pockets and a bottom cover sealing the inspection holes.

FIG. 4 is a schematic representation, side perspective view, of a package of the disclosure showing the layering structure of a container with a shaped pocket, an inspection hole in the bottom of the shaped pocket extending through each layer of the container, and top and bottom covers.

FIG. 5 is a schematic representation, side perspective view, of a carrier tape of the prior art wherein the product-containing pockets are covered by discrete film patches.

### DETAILED DESCRIPTION

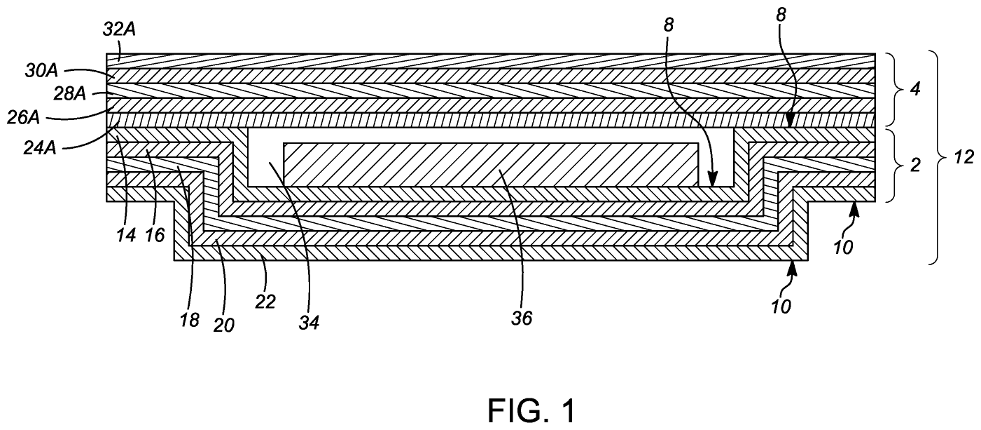

An exemplary package 12 of this disclosure is illustrated in FIG. 1, showing a shaped container 2 sealed with a top cover 4. The shaped container 2 is formed from a multilayer film and has a top surface 8 and a bottom surface 10, and the container 2 is shaped (e.g., embossed; molded; punched) to have one or more pockets (recesses) 34. Each pocket 34 is shaped to store product(s) 36. The top cover 4, also a film, is attached to the top surface 8 of container 2, sealing the container 2 to protect product(s) 36. Optionally, the package 12 may also be shaped so that it includes additional pockets 34 formed by shaping (e.g., embossing) the film of the container 2 at both the container top surface 8 and the bottom surface 10. In either embodiment (i.e., pockets formed at the top surface 8 only or both the top surface 8 and bottom surface 10), a bottom cover 6, which is also a film, is attached to bottom surface 10.

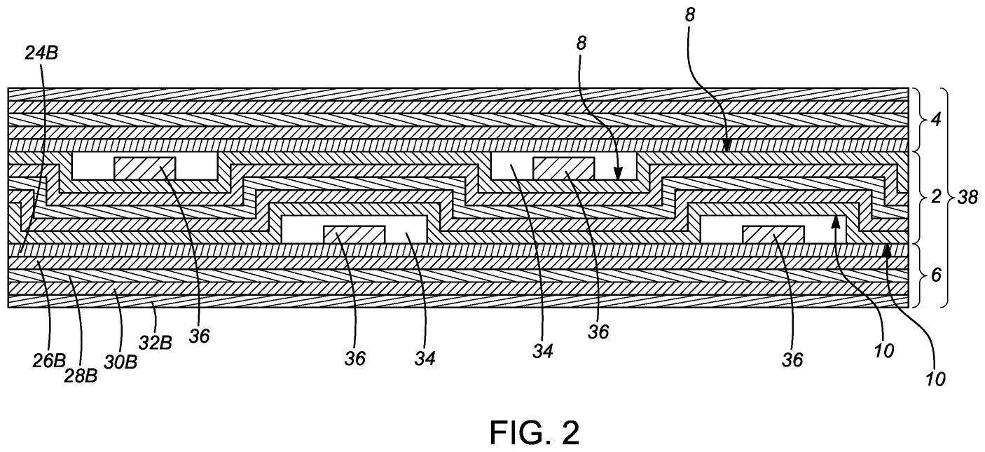

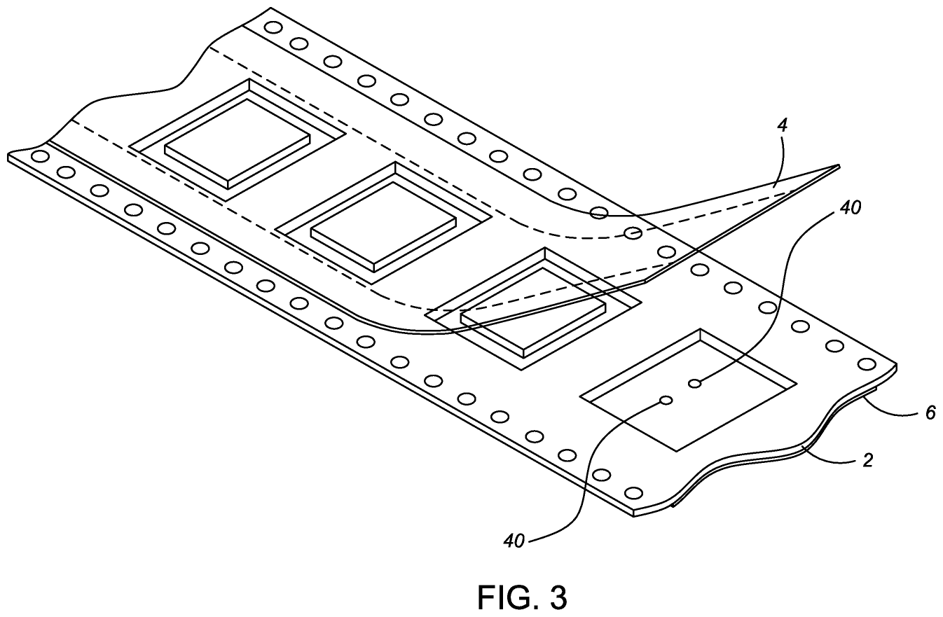

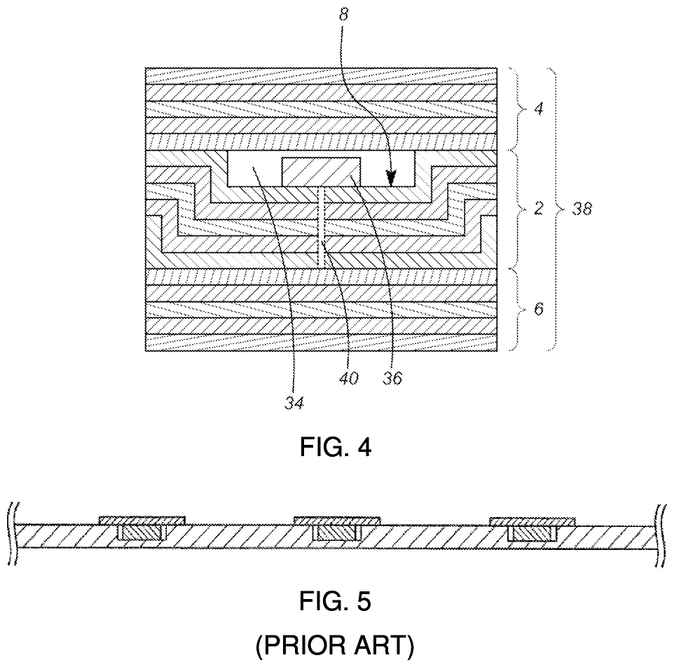

As schematically illustrated in FIG. 2, the package 12 is preferably in the form of a carrier tape having multiple pockets 34 formed between the top cover 4 and top container surface 8. A carrier tape structure is illustrated in FIG. 3. As illustrated in FIG. 3, it is typical in a conventional carrier tape to be punched with sprocket/feed holes on either side of the shaped cavity, which are used to guide and feed the carrier tape through processing equipment. However, in the context of this disclosure, inspection holes are optionally punched into the bottom of each pocket 34 to allow processing equipment to detect if a pocket 34 is filled with a product 36. Any number of such inspection holes may be punched into the pocket bottoms, with a pocket having 2 inspection holes being illustrated in FIG. 3 and FIG. 4. In such an embodiment, bottom cover 6 will seal those holes at the bottom of the pocket. When those detector holes are not added, the bottom cover 6 still aids in enhancing the barrier properties of the package.

Each of the covers 4 and 6 may independently comprise monolayer films that consist of a single fluoropolymer layer (exclusive of any required adhesive layer), or may independently be a multilayered film where one or more additional polymer or non-polymer layers are attached to the fluoropolymer layer. As illustrated in FIG. 1 and FIG. 2, the container 2 is preferably a multilayer film, such as a five-layer multilayer film incorporating a first base layer 14 attached to a first fluoropolymer layer 18 via a first intermediate adhesive layer 16, and a second base layer 22 attached to the first fluoropolymer layer 18 via a second intermediate adhesive layer 20. Top cover 4 is also a preferably a multilayer film, such as a three-layer film incorporating a first heat seal layer 24A attached to a second fluoropolymer layer 28A via a third intermediate adhesive layer 26A. In this embodiment, the first heat seal layer 24A is attached to the first base layer 14 of the container 2. As illustrated in FIG. 1 and FIG. 2, in a preferred embodiment, top cover 4 may be a five-layer film wherein a first support layer 32A is attached to the second fluoropolymer layer 28A via a fourth intermediate adhesive layer 30A.

As illustrated in FIG. 2, in a package 38 that includes pouches 34 shaped from the top surface 8 of the container 2 wherein both a top cover 4 and a bottom cover 6 are included as part of the package structure 38. The bottom cover 6 is also a film, preferably a multilayer film incorporating a second heat seal layer 24B attached to a third fluoropolymer layer 28B via a fifth intermediate adhesive layer 26B. In this embodiment, the second heat seal layer 24B is attached to the second base layer 22 of the container 2. As particularly illustrated in FIG. 2, bottom cover 6 may be a five-layer film wherein a second support layer 32B is attached to the third fluoropolymer layer 28B via a sixth intermediate adhesive layer 30B.

In each of the shaped container 2 as well as the top cover 4 and bottom cover 6, the fluoropolymer layer (also referred to herein as a fluorine-containing polymer layer) may be comprised of one or more homopolymers or copolymers or blends thereof as are well known in the art and are described in, for example, U.S. Pat. Nos. 4,510,301; 4,544,721 and 5,139,878. Of these, particularly preferred fluoropolymers suitable to form multilayer films of the present disclosure include homopolymers and copolymers of chlorotrifluoroethylene, copolymers of ethylene-chlorotrifluoroethylene; copolymers of chlorotrifluoroethylene and vinylidene fluoride, and copolymers of chlorotrifluoroethylene and tetrafluoroethylene. Such copolymers of chlorotrifluoroethylene may contain up to 10%, and preferably up to 8% by weight of the other co-monomers such as vinylidene fluoride and tetrafluoroethylene. As used herein, copolymers include polymers having two or more monomer components. Most preferred fluoropolymer layers in each embodiment of this disclosure comprise, consist of or consist essentially of polychlorotrifluoroethylene (PCTFE) homopolymer resins. Such are available as ACLON® resin or in film form, as ACLAR® films or HYDROBLOCK® films, each from Honeywell International Inc. of Charlotte, North Carolina. ACLAR® and HYDROBLOCK® PCTFE fluoropolymer films are crystal clear, chemically stable, biochemically inert films that provide an excellent moisture barrier for a clean, thermoformable film. They are plasticizer and stabilizer free, and provide up to 10 times the moisture barrier of other transparent blister packaging films. The fluoropolymer films are also antistatic, exhibit excellent electrical properties and can be laminated and metallized. They are commercially available in a variety of thicknesses and for the purposes of this disclosure an ACLAR® or HYDROBLOCK® PCTFE layer preferably has a thickness of from about 1 μm to about 150 μm, more preferably from about 1 μm to about 100 μm and most preferably from about 10 μm to about 50 μm, whether oriented or non-oriented.

Each of the covers of this disclosure may independently be a monolayer film that consists of a single fluoropolymer layer (exclusive of a required adhesive layer), but as stated above, each is preferably independently a multilayered film where one or more additional support layers are attached to the fluoropolymer layer. In the preferred embodiments described herein, the top cover includes at least one support layer 32A and the bottom cover includes at least one support layer 32B, wherein said support layers 32A, 32B may be polymer layers or non-polymer layers. Suitable polymeric support layers non-exclusively include those formed from polyamide homopolymers, polyamide copolymers, polyolefins including linear or branched polyolefin homopolymers, linear or branched polyolefin copolymers, cyclic olefin homopolymers, cyclic olefin copolymers, copolymers of cyclic olefins and linear or branched polyolefin homopolymers, and copolymers of cyclic olefins and linear or branched polyolefin copolymers, ethylene vinyl acetate copolymers, ethylene vinyl alcohol copolymers, polyesters such as polyethylene terephthalate (PET) or polyethylene naphthalate (PEN) or blends thereof, polyvinyl chloride, polyvinylidene chloride, polystyrene (PS), styrenic copolymers, polyisoprene, polyurethanes, ethylene ethyl acrylate, ethylene acrylic acid copolymers, polycarbonate, acrylonitrile butadiene styrene (ABS) copolymers, and blends of any of the foregoing materials. Suitable non-polymer layers non-exclusively include paper and metal foils, such as an aluminum foil, as is commonly-used in blister packages for the storage of pharmaceuticals.

Suitable polyamides (nylons) within the scope of the disclosure non-exclusively include homopolymers or copolymers selected from aliphatic polyamides and aliphatic/aromatic polyamides having a molecular weight of from about 10,000 to about 100,000. Useful polyamide homopolymers include poly(4-aminobutyric acid) (nylon 4), poly(6-aminohexanoic acid) (nylon 6, also known as poly(caprolactam)), poly(7-aminoheptanoic acid) (nylon 7), poly(8-aminooctanoic acid)(nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12), nylon 4,6, poly(hexamethylene adipamide) (nylon 6,6), poly(hexamethylene sebacamide) (nylon 6,10), poly(heptamethylene pimelamide) (nylon 7,7), poly(octamethylene suberamide) (nylon 8,8), poly(hexamethylene azelamide) (nylon 6,9), poly(nonamethylene azelamide) (nylon 9,9), poly(decamethylene azelamide) (nylon 10,9), poly(tetramethylenediamine-co-oxalic acid) (nylon 4,2), the polyamide of n-dodecanedioic acid and hexamethylenediamine (nylon 6,12), the polyamide of dodecamethylenediamine and n-dodecanedioic acid (nylon 12,12) and the like. Useful aliphatic polyamide copolymers include caprolactam/hexamethylene adipamide copolymer (nylon 6,6/6), hexamethylene adipamide/caprolactam copolymer (nylon 6/6,6), trimethylene adipamide/hexamethylene azelamide copolymer (nylon trimethyl 6,2/6,2), hexamethylene adipamide-hexamethylene-azelamide caprolactam copolymer (nylon 6,6/6,9/6) and the like. Also included are other nylons which are not particularly delineated here. Preferred polyamides include nylon 6, nylon 6,6, nylon 6/6,6 as well as mixtures of the same.

Aliphatic polyamides used in the practice of this disclosure may be obtained from commercial sources or prepared in accordance with known preparatory techniques. For example, poly(caprolactam) can be obtained from Honeywell International Inc., Morristown, New Jersey under the trademark CAPRON®.

Exemplary of aliphatic/aromatic polyamides include poly(tetramethylenediamine-co-isophthalic acid) (nylon 4,I), polyhexamethylene isophthalamide (nylon 6,I), hexamethylene adipamide/hexamethylene-isophthalamide (nylon 6,6/6I), hexamethylene adipamide/hexamethyleneterephthalamide (nylon 6,6/6T), poly(2,2,2-trimethyl hexamethylene terephthalamide), poly(m-xylylene adipamide) (MXD6), poly(p-xylylene adipamide), poly(hexamethylene terephthalamide), poly(dodecamethylene terephthalamide), polyamide 6T/6I, polyamide 6/MXDT/I, polyamide MXDI, and the like. Blends of two or more aliphatic/aromatic polyamides can also be used. Aliphatic/aromatic polyamides can be prepared by known preparative techniques or can be obtained from commercial sources. Other suitable polyamides are described in U.S. Pat. Nos. 4,826,955 and 5,541,267, which are incorporated herein by reference.

Suitable polyolefins for use herein include polymers of alpha-olefin monomers having from about 3 to about 20 carbon atoms and include homopolymers, copolymers (including graft copolymers), and terpolymers of alpha-olefins. Illustrative homopolymer examples include low density polyethylene (LDPE), ultra-low density polyethylene (ULDPE), linear low density polyethylene (LLDPE), metallocene linear low density polyethylene (m-LLDPE), medium density polyethylene (MDPE), and high density polyethylene (HDPE), polypropylene, polybutylene, polybutene-1, poly-3-methylbutene-1, poly-pentene-1, poly-4,4 dimethylpentene-1, poly-3-methyl pentene-1, polyisobutylene, poly-4-methylhexene-1, poly-5-ethylhexene-1, poly-6-methylheptene-1, polyhexene-1, polyoctene-1, polynonene-1, polydecene-1, polydodecene-1 and the like.

Illustrative copolymers and terpolymers include copolymers and terpolymers of alpha-olefins with other olefins such as ethylene-propylene copolymers; ethylene-butene copolymers; ethylene-pentene copolymers; ethylene-hexene copolymers; and ethylene-propylene-diene copolymers (EPDM). The term polyolefin as used herein also includes acrylonitrile butadiene styrene (ABS) polymers, copolymers with vinyl acetate, acrylates and methacrylates and the like. Preferred polyolefins are those prepared from alpha-olefins, most preferably ethylene polymers, copolymers, and terpolymers. The above polyolefins may be obtained by any known process. The polyolefins may have a weight average molecular weight of about 1,000 to about 1,000,000, and preferably about 10,000 to about 500,000 as measured by high performance liquid chromatography (HPLC). Preferred polyolefins are polyethylene, polypropylene, polybutylene and copolymers, and blends thereof. The most preferred polyolefin is polyethylene. The most preferred polyethylenes are low density polyethylenes.

Suitable cyclic (cyclo) olefin polymers (homopolymers, copolymers or blends) are described, for example, in U.S. Pat. Nos. 5,218,049; 5,783,273 and 5,912,070, which are incorporated herein by reference. U.S. Pat. No. 5,218,049 discloses films composed of cyclic olefins. U.S. Pat. No. 5,783,273 discloses press-through blister packaging materials comprising a sheet of a cyclic olefin copolymer. U.S. Pat. No. 5,912,070 discloses a packaging material comprising a layer of a cyclic olefin, a layer of a polyester and an intermediate adhesive. Cyclic olefins may be obtained commercially from Mitsui Petrochemical Industries, Ltd. of Tokyo, Japan, or Ticona of Summit, New Jersey.

Most preferably, both the first support layer 32A and the second support layer 32B comprise, consist of or consist essentially of polyethylene terephthalate. Each of the above-mentioned polyolefin polymers are also suitable for the fabrication of the first heat seal layer 24A of the top cover 4 and the second heat seal layer 24B of the bottom cover 6. Useful heat seal layers 24A, 24B may also comprise ethylene vinyl acetate (EVA) copolymers, ethylene-propylene (EP) copolymers, ethylene-propylene-butene (EPB) terpolymers, or combinations thereof. The most preferred heat seal layer 24A, 24B in each of the top cover 4 and bottom cover 6 comprises, consists of or consists essentially of low density polyethylene (LDPE).

As stated above, shaped container 2 contains at least one fluoropolymer (fluorine-containing) layer 18 and at least a first base layer 14 attached to the fluoropolymer layer via a first intermediate adhesive layer 16. The first base layer 14 and optional second base layer 22 provide the container with the structural integrity sufficient to retain its shaped structure after being embossed or otherwise molded to form pockets 34. The fluoropolymer layer 18 provides the desired barrier properties. Suitable base layers 14 and 22 non-exclusively include each of the polymeric layers disclosed herein as suitable for said support layers 32A, 32B. Most preferably, both the first base layer 14 and second base layer 22 comprise, consist of or consist essentially of polystyrene.

In the preferred embodiments of this disclosure, adjacent layers within each of the container 2, top cover 4 and bottom cover 6 are attached via an intermediate adhesive layer, also referred to in the art as a “tie” layer, between the layers. Any conventionally known adhesive material may be used herein as any of the intermediate adhesive layers. Suitable adhesive polymers non-exclusively include polyurethanes, epoxies, ethylene vinyl acetate copolymers, polyesters, acrylics, modified polyolefin compositions, and blends thereof. In this regard, preferred modified polyolefin compositions are those having at least one functional moiety selected from the group consisting of unsaturated polycarboxylic acids and anhydrides thereof. Such unsaturated carboxylic acid and anhydrides include maleic acid and anhydride, fumaric acid and anhydride, crotonic acid and anhydride, citraconic acid and anhydride, itaconic acid an anhydride and the like. Of these, the most preferred is maleic anhydride. The modified polyolefins suitable for use in this disclosure include compositions described in U.S. Pat. Nos. 3,481,910; 3,480,580; 4,612,155 and 4,751,270. Other adhesive layers non-exclusively include alkyl ester copolymers of olefins and alkyl esters of α,β-ethylenically unsaturated carboxylic acids such as those described in U.S. Pat. No. 5,139,878. The preferred modified polyolefin composition comprises from about 0.001 and about 20 weight percent of the functional moiety, based on the total weight of the modified polyolefin. More preferably the functional moiety comprises from about 0.05 and about 10 weight percent, and most preferably from about 0.1 and about 5 weight percent. The modified polyolefin composition may also contain up to about 40 weight percent of thermoplastic elastomers and alkyl esters as described in U.S. Pat. No. 5,139,878. Particularly preferred are polyurethane-based adhesive layers, including both polyester-based polyurethanes and polyether-based polyurethanes, wherein each of said intermediate adhesive layers in each embodiment of this disclosure comprises, consists of or consists essentially of one or more polyurethanes (one or more urethane-based adhesives), such as hydroxyl-terminated polyurethanes. Preferred urethane-based adhesives are commercially available, for example, from Henkel Technologies, based in Düsseldorf, Germany, including polyurethanes commercially available from the Liofol Company (a division of Henkel Technologies) under the trademark TYCEL®.

In preferred embodiments of the disclosure, multilayered cover films 4, 6 comprise either three- or five-layered polymer film structures, inclusive of adhesive tie layers between adjacent polymer layers aiding in the attachment of the layers to each other. Particularly preferred three-layer films for the top cover 4 and bottom cover 6 include a fluoropolymer/adhesive/polyester construction where the fluoropolymer is the outermost layer of the cover, which polyester is polyethylene terephthalate. In another preferred three-layer films for the top cover 4 and bottom cover 6 include a fluoropolymer/adhesive/polyolefin construction where the fluoropolymer is the outermost layer of the cover, which polyolefin is a, for example, a polyethylene, polypropylene or cyclic olefin homopolymer or copolymer. In yet another preferred embodiment, a three-layer film construction for the covers 4 and 6 comprises a fluoropolymer/adhesive/polyamide construction with the fluoropolymer being the outermost film layer, which polyamide, for example, is a nylon 6, nylon 6,6 or nylon 6,6,6 polymer. Other preferred constructions include, for example, fluoropolymer/adhesive/polyvinyl chloride and fluoropolymer/adhesive/polyvinylidene chloride. In each of these embodiments, the layering structure of each of top cover 4 and bottom cover 6 are independent of one another, i.e., each may have the same layering construction or may have different layering constructions relative to each other. Preferred five-layer constructions for the top cover 4 and bottom cover 6 include polyester (e.g., PET)/adhesive/fluoropolymer (e.g., PCTFE)/adhesive/polyolefin (e.g., LDPE), and polyester/adhesive/fluoropolymer/adhesive/polyamide (e.g., nylon 6).

Such constructions are exemplary and non-limiting, and each of the layers within each of top cover 4 and bottom cover 6 may generally comprise any polymeric (or non-polymeric) material that is suitable for use in a multilayered film so long as at least one film layer comprises a fluoropolymer (fluorine-containing) layer. Thus, each cover 4, 6 independently may comprise three, four, five, or even more layers as desired by the skilled artisan. Similarly, each of the layers of the container 2 may generally comprise any polymeric material that is suitable for use in a multilayered film so long as at least one film layer comprises a fluoropolymer (fluorine-containing) layer and at least one non-fluoropolymer base layer 14 is incorporated for structural strength.

Each polymer layer of the container 2 and/or covers 4, 6 may optionally also include one or more conventional additives whose uses are well known to those skilled in the art. The use of such additives may be desirable in enhancing the processing of the compositions as well as improving the products or articles formed therefrom. Examples of such include: oxidative and thermal stabilizers, lubricants, release agents, flame-retarding agents, oxidation inhibitors, oxidation scavengers, dyes, pigments and other coloring agents, ultraviolet light absorbers and stabilizers, organic or inorganic fillers including particulate and fibrous fillers, reinforcing agents, nucleators, plasticizers, as well as other conventional additives known to the art. Such may be used in amounts, for example, of up to about 10% by weight of the overall layer composition. Representative ultraviolet light stabilizers include various substituted resorcinols, salicylates, benzotriazole, benzophenones, and the like. Suitable lubricants and release agents include stearic acid, stearyl alcohol, and stearamides. Exemplary flame-retardants include organic halogenated compounds, including decabromodiphenyl ether and the like as well as inorganic compounds. Suitable coloring agents including dyes and pigments include cadmium sulfide, cadmium selenide, titanium dioxide, phthalocyanines, ultramarine blue, nigrosine, carbon black and the like. Representative oxidative and thermal stabilizers include the Period Table of Element's Group I metal halides, such as sodium halides, potassium halides, lithium halides; as well as cuprous halides; and further, chlorides, bromides, iodides. Also, hindered phenols, hydroquinones, aromatic amines as well as substituted members of those above mentioned groups and combinations thereof. Exemplary plasticizers include lactams such as caprolactam and lauryl lactam, sulfonamides such as o,p-toluenesulfonamide and N-ethyl, N-butyl benzene-sulfonamide, and combinations of any of the above, as well as other plasticizers known to the art.

Multilayer films suitable for the fabrication of each of the container 2, top cover 4 and bottom cover 6 of this disclosure can be formed by any conventional technique for forming films, including lamination and coextrusion. In the most preferred method, the multilayered films are formed by coextrusion. For example, the material for the individual layers are fed into infeed hoppers of the extruders of like number, each extruder handling the material for one or more of the layers. The melted and plasticized streams from the individual extruders are fed into a single manifold co-extrusion die. While in the die, the layers are juxtaposed and combined, then emerge from the die as a single multiple layer film of polymeric material. After exiting the die, the film is cast onto a first controlled temperature casting roll, passes around the first roll, and then onto a second controlled temperature roll, which is normally cooler than the first roll. The controlled temperature rolls largely control the rate of cooling of the film after it exits the die. The temperatures of the various rolls are selected to achieve the desired properties of the film and are also based on the type of polymer employed. Typically, the first casting roll temperature is in the range of about 50° F. to about 250° F. (10° C. to 121° C.), preferably in the range of about 75° F. to about 200° F. (24° C. to 93° C.), and more preferably in the range of about 100° F. to about 175° F. (38° C. to 79° C.). The temperature of the second controlled temperature roll (also called a preheat roll) is typically in the range of about 50° F. to about 250° F. (10° C. to 121° C.), preferably in the range of about 75° F. to about 200° F. (24° C. to 93° C.), and more preferably in the range of about 100° F. to about 175° F. (38° C. to 79° C.). The temperature of the rolls need not be the same. A cool roll may be employed to provide dimensional stability to the film. Typically, the temperature of this roll is in the range of about 50° F. to about 300° F. (10° C. to 149° C.), preferably in the range of about 100° F. to about 250° F. (38° C. to 121° C.), and more preferably in the range of about 150° F. to about 225° F. (66° C. to 107° C.).

In another method, the film forming apparatus may be one which is referred to in the art as a “blown film” apparatus and includes a multi-manifold circular die head for bubble blown film through which the plasticized film composition is forced and formed into a film “bubble which may ultimately be collapsed and formed into a film. Processes of coextrusion to form film and sheet laminates are generally known. See for example in “Modern Plastics Encyclopedia”, Vol. 56, No. 10A, pp. 131-132, McGraw Hill, October 1979.

Alternatively, the individual layers may first be formed as separate layers and then laminated together under heat and pressure with or without intermediate adhesive layers. Lamination techniques are well known in the art. Typically, laminating is done by positioning the individual layers on one another under conditions of sufficient heat and pressure to cause the layers to combine into a unitary film. Typically the individual layers are positioned on one another, and the combination is passed through the nip of a pair of heated laminating rollers by techniques well known in the art. Lamination heating may be done at temperatures ranging from about 120° C. to about 175° C., preferably from about 150° C. to about 175° C., at pressures ranging from about 5 psig (0.034 MPa) to about 100 psig (0.69 MPa), for from about 5 seconds to about 5 minutes, preferably from about 30 seconds to about 1 minute.

The mono/multilayer films of this disclosure may optionally be stretched or oriented in any direction, if so desired, using methods known to those of skill in the art. In such a stretching operation, the layer/film may be stretched in either the direction coincident with the direction of movement of the film being withdrawn from the casting roll, also referred to as “machine direction,” or may be stretched in the direction which is perpendicular to the machine direction, also referred to in the art as the “transverse direction,” such that the resulting film is “mono-axially” or “uni-axially” oriented. Alternatively, the mono/multilayer films of the disclosure may be stretched in both the machine direction and the transverse direction, whereby the resulting film is “biaxially” oriented. Typically for use in the present disclosure, films are oriented at draw ratios of from about 1.5:1 to about 10:1, and preferably at a draw ratio of from about 1.5:1 to about 4:1 it the machine and/or transverse directions. The term “draw ratio” as used herein indicates the increase of dimension in the direction of the draw. Therefore, a film having a draw ratio of 2:1 has its length doubled during the drawing process. Generally, a film is drawn by passing it over a series of preheating and heating rolls. The heated film moves through a set of nip rolls downstream at a faster rate than the film entering the nip rolls at an upstream location. The change of rate is compensated for by stretching in the film.

Typical processes and ranges of conditions for mono-axially oriented polyamide films are disclosed, for example, in U.S. Pat. No. 4,362,385. The mono/multilayer films of the present disclosure can also be biaxially oriented using a blown tube apparatus or a tenter-frame apparatus, which are well known in the art, and films being biaxially stretched may either be drawn sequentially or simultaneously in the two biaxial directions.

Each individual film layer and each overall multilayer film of this disclosure may have any desired thickness. For example, each individual film may have a thickness after optional orientation of from about 0.1 mil (2.5 μm) to about 15 mils (381 μm), more preferably from about 0.2 mil (5.1 μm) to about 5 mils (127 μm), and most preferably from about 0.5 mil (12.7 μm) to about 2 mils (50.8 μm). Each of the container 2, top cover 4 and bottom cover 6 may have a thickness after optional orientation of from about 20 μm to about 1000 μm, more preferably from about 30 μm to about 600 μm, and most preferably from about 50 μm to about 500 μm. The thickness of each film before stretching is selected such that the desired thickness after stretching is achieved, based on the stretch ratio employed, as is known in the art. While such thicknesses are referenced, it is to be understood that other layer thicknesses may be produced to satisfy a particular need and yet fall within the scope of the present disclosure.

After fabrication and optional stretching, the multilayer film used to form the shaped container 2 is shaped to form one or more pockets, using conventional embossing or molding techniques. In a preferred embodiment, the shaped container 2 is to be fabricated into a carrier tape such as illustrated in FIG. 3, wherein a plurality of spaced apart pockets are sequentially punched or embossed into the film along a longitudinal axis of the tape. Suitable techniques for forming said carrier tapes with a plurality of pockets are well known in the art. See, for example, U.S. pre-grant publication 2017/0162418, U.S. Pat. Nos. 9,635,791 and 9,911,079, each of which is incorporated herein by reference to the extent consistent herewith, each teach carrier tape designs including pockets/recesses formed in continuous polymeric strips, which are suitable for packaging miniature electronic components as is intended herein. As described in U.S. 2017/0162418, the pockets are made by thermoforming a sheet or strip of the multilayer film of the container 2 with a suitable die or dies having the desired dimensions. In this regard, the multilayer film of the container 2 may be pre-heated or the die itself may be heated to aid in thermoforming process, as is well known in the art to form pockets having the desired size and shape, wherein each pocket includes a bottom wall and four side walls extending from said bottom wall, wherein the bottom wall is generally planar and parallel with the surfaces 8, 10 of the cover. The walls may be oriented at approximately 90° giving the pouches a generally square or rectangular shape, or they may be fabricated to have any other shape as may be determined by one skilled in the art. The shape and/or dimensions of the pockets/recesses are not intended to be limiting herein. However, in the preferred embodiments, the pockets/recesses are generally square or rectangular in shape with length and width dimensions of from about 0.5 mm to about 100 mm, more preferably from about 0.5 mm to about 80 mm and most preferably from about 1 mm to about 70 mm, and having a depth of from about 0.5 mm to about 15 mm, more preferably from about 0.5 mm to about 12 mm and most preferably from about 1 mm to about 10 mm. However, these preferences are not intended to be limiting.

Similarly, the dimensions of the carrier tape itself are not intended to be limiting, but a typical carrier tape will have a width of from about 5 mm to about 100 mm, more preferably from about 5 mm to about 88 mm, and most preferably from about 8 mm to about 72 mm. A typical carrier tape will have a continuous length of from about 1 m to about 300 m, more typically from about 1 m to about 200 m. In a preferred carrier tape, the pockets/recesses are preferably spaced apart from each other by from about 1 mm to about 10 mm, more preferably from about 3 mm to about 8 mm and most preferably from about 3 mm to about 5 mm. The side margins of the carrier tape beside the pockets may also vary depending on the desired dimensions of the pockets and the desire for sprocket holes on one side margin or both side margins (such as illustrated in FIG. 3), and typically range from about 2 mm to about 5 mm in width.

The pockets are then filled with the desired product 36, such as a microchip or other small electronic component, also using well known techniques in the art. The thermoformed carrier tape is then typically cooled and solidified, if necessary. After the pockets are suitably filled, they are to be sealed shut with top cover 4 and bottom cover 6, such as illustrated in FIG. 2. After filling of one or more of the pockets 34 with a product 36, the pockets are then sealed shut with the covers 4, 6. Methods of sealing the covers 4, 6 to the shaped container 2 are conventionally known and the preferred method is heat sealing. As illustrated in U.S. Pat. No. 9,911,079, this method may include applying the cover film(s) 4, 6 as a continuous film to the entirety of the surface area of the shaped container/carrier tape 2, as is illustrated in FIG. 4C of U.S. Pat. No. 9,911,079, or in the alternative, smaller discrete patches of the cover film(s) 4, 6 may be selectively applied only to seal shut the individual shaped pouch areas, whereby the patches are non-continuous and are spaced apart from each other, such as shown in FIG. 4E of U.S. Pat. No. 9,911,079 and FIG. 5 of this disclosure. However, the method of applying the cover films 4, 6 to the shaped container 2 is not intended to be limiting.

As is well known in the art, the carrier tape may also be subjected to other processing steps, such as punching advancement holes along at least one of the edges of the tape, as may be desired. Additionally, at least one of the outer layers of cover 4 and/or 6 may have a printable surface and may be printed with decorative and/or informational indicia. The covers 4, 6 may also be fabricated with a pull tab in order to ease finger peeling removal, if eventual manual separation of the cover films from the shaped container 2 is intended to allow access the stored product. Such peeling may be performed manually by an operator or may be automated. It should also be understood that this disclosure is not intended to be limited by the method used to form such carrier tapes and the methods described in U.S. pre-grant publication 2017/0162418, U.S. Pat. Nos. 9,635,791 and 9,911,079 are not intended to be strictly limiting.

The fully assembled packages 12, 38 of this disclosure will have improved water vapor and oxygen transmission barriers relative to other carrier tapes/packages of the prior art. The water vapor transmission rate (WVTR) of such articles of the disclosure may be determined via the procedure set forth in ASTM F1249. In the preferred embodiment, the packages of this disclosure have a WVTR per mil of film preferably less than about 0.05 g/100 in²/day (0.775 g/m²/day) at 37.8° C. and 100% RH, more preferably less than about 0.03 g/100 in²/day (0.465 g/m²/day), and most preferably less than about 0.015 g/100 in²/day (0.233 g/m²/day), as determined by water vapor transmission rate measuring equipment available from, for example, Mocon. Preferably, the packages of this disclosure have water vapor transmission rates that are at least about 20% less than the water vapor transmission rates of similar packages, more preferably at least about 25% less than the water vapor transmission rates of similar packages, and most preferably at least about 30% less than the water vapor transmission rates of similar packages.

The oxygen transmission barrier is typically measured at 23° C./50% Relative Humidity (RH) using the procedure of ASTM F1927. In general, using the aforesaid method, the packages of the disclosure also preferably have an oxygen transmission rate (O₂ TR) at 50% RH equal to or less than about 7 cm³/100 in² (645 cm²)/24 hours/atm at 23° C. The O₂ TR of the covers 4, 6 preferably have an oxygen transmission rate less than or equal to that of the container 2. The superior oxygen barrier properties of the packages of this disclosure makes them especially useful in electronic component storage applications.

In use, a carrier tape is formed with a conventional carrier tape forming machine as is commonly used in the industry, wherein a strip of film (tape) is pre-heated and then shaped to have the above-described pockets/cavities by conventional thermoforming or embossing techniques, or the like. Optionally, the bottom of the pockets/cavities may be punched with one or more holes, which allow for the mechanical verification that a product is stored within the pockets/cavities, as is known in conventionally known in the art. Thereafter, the pockets/cavities are then filled with one or more products, followed by sealing the pockets/cavities with the top cover 4 and bottom cover 6, to form a sealed tape. The sealed tape may then be wound onto a reel for storage (e.g., a 3-inch to 7-inch reel, as is typical in the industry, which typically hold about 100-400 meters of tape). The end user will then peel off the top cover 4, such as is illustrated in FIG. 3, exposing the stored parts, then the parts are removed and used/installed as desired. These removal and installation steps are typically mechanically automated, but may also be performed manually.

The following examples serve to illustrate the preferred embodiments:

### Examples

### A. Multilayer Film Lamination—Container Sheet

A 51 μm clear PCTFE homopolymer film (ACLAR® film, commercially available from Honeywell International Inc.) was laminated between two 200 μm black polystyrene (PS) films, with a solvent-based, two-component (i.e., polyol and diisocyanate) polyurethane adhesive layer. The polyurethane adhesive comprised a polyester polyol terminated with hydroxyl groups and a polyester-based methylene diphenyl diisocyanate (MDI) applied between each of the layers, with each adhesive layer having a dry coating weight of about 3-4 grams. The five-layer laminate was then transferred to a curing room held at a temperature of 45° C. and at 50% RH for 72 hours to fully cure the two adhesive layers.

### B. Cover Film:

A 15 μm ACLAR® PCTFE homopolymer film was laminated to a 20 μm transparent polyethylene terephthalate (PET) film, also with the same solvent-based, two-component polyurethane adhesive layer as used in forming the container sheet being applied between each of the layers, with the adhesive layer having a dry coating weight of about 3-4 grams. The five-layer laminate was then transferred to a curing room held at a temperature of 45° C. and at 50% RH for 72 hours to fully cure the adhesive layer. After curing, a 10 μm ethylene vinyl acetate (EVA) copolymer resin (melt index 25-40 g/10 min according to ASTM D1238) sealing resin was coated on to the PET surface via extrusion coating.

### C. Forming and Sealing

The container sheet from A was slit into continuous 24 mm wide strips, while the cover film from B was slit into continuous 12 mm wide strips, each being cut from a master roll of film using a conventional industrial slitter (although any other suitable slitting means would be acceptable). A strip of container sheet A was then softened by passing it through a pre-heating station set at 110° C. at a speed of 2 m/min. After softening, a cover sheet strip was embossed by passage through an embossing station wherein a series of pockets having dimensions of 1 mm×12 mm×1.8 mm were formed in the strip, with an embossing pressure of 3 bar (300 kPa). After the strip passed through the embossing station it was then passed through a punching station to punch two 0.3 mm diameter holes into the bottom of each pocket with two needles which were installed on the upper side of the punching station. The thusly formed carrier tape was then wound onto a spool around a 3-inch core. Thereafter, the formed tapes were unwound and transferred to filling-sealing machine wherein electronic parts were first inserted into each cavity and then sealed by applying one lidding film to each of the top and bottom surfaces of the carrier tape. The sealed tape was then rewound on the spool and stored.

### Barrier Validation

Blue humidity indicator paper was used to validate the barrier of the cavity. If the humidity inside of the cavity was higher than 20%, then the indicator paper would turn pink. Three sample carrier tape strips, each having 100 pockets/cavities, were placed into a humidified chamber which was maintained at 20° C. and 80% RH, and after 3-weeks the indicator papers were still blue. The calculated moisture permeation rate of the sealed carrier tape was approximately 0.033 mg/cavity/day at 40° C./75% RH.

Barrier properties were also evaluated by comparing representative samples where both the cover (lid) film and the container forming sheet incorporated a PCTFE layer with comparative samples that had a PCTFE layer in just one of the cover (lid) film or the container forming sheet.

### Sample 1: PCTFE Films on Both Container Surfaces

A 63 μm thick PCTFE film was laminated together with a 50 μm thick layer of low density polyethylene (LDPE) using an intermediate adhesive layer that was the same solvent-based, two-component polyurethane adhesive as used for the container sheet and cover film. Two of these multilayer films were then heat sealed together (LDPE to LDPE, directly without an intermediate adhesive) to form a 12 cm×14 cm size pouch (container) having two outer PCTFE films. The four edges of the pouch were heat sealed together one at a time with a 10 mm width sealing band. Before sealing shut the final edge, 50 granules of silica gel desiccant were placed into the pouch and set aside as Sample 1.

### Sample 2: PCTFE Film on One Container Surface

A PCTFE/adhesive/LDPE film as formed for Sample 1 was heat sealed to a PET/EVA film (50 μm thick layer of polyethylene terephthalate/10 μm thick layer of ethylene vinyl acetate) to form a pouch as was formed for preparing Sample 1, with the LDPE film being heat sealed directly to the EVA film (i.e., without an intermediate adhesive). The thus formed pouch was filled with 50 granules of silica gel desiccant as in Sample 1 and was set aside as Sample 2.

The original weight of both samples were recorded as the Day 0 weight for each sample. Both samples were then placed into a humidity chamber set at 60° C. and 85% RH for 24-hours to allow moisture to permeate into the pouches via the pouch walls. The samples were then removed from the chamber and allowed to sit at standard atmospheric room conditions (i.e., at a temperature of approximately 25° C. and 50% relative humidity) for 1-hour, allowing the outer pouch surfaces to naturally dry. Then the weight of both samples were checked and identified as the Day 1 weight for each sample. The Day 1 weight minus the Day 0 weight for each sample was the amount of moisture permeated into the pouch via the pouch walls. The results showed that the sample having two layers of PCTFE (Sample 1) had a moisture permeation of 0.02971 grams/container, while the other sample with just one layer of PCTFE (Sample 2) had a moisture permeation of 0.59126 grams/container, which was approximately 20 times higher than the sample having PCTFE films on both sides.

While the present disclosure has been particularly shown and described with reference to preferred embodiments, it will be readily appreciated by those of ordinary skill in the art that various changes and modifications may be made without departing from the spirit and scope of the disclosure. It is intended that the claims be interpreted to cover the disclosed embodiment, those alternatives which have been discussed above and all equivalents thereto.

What is claimed is:

1. A package comprising:
a) a shaped container comprising a multilayer film, the container comprising one or more pockets, said container having a top surface and a bottom surface, the multilayer film comprising:
i. a first base layer;
ii. first intermediate adhesive layer;
iii. a first fluoropolymer layer adhered to the first base layer via the first intermediate adhesive layer;
iv. a second intermediate adhesive layer; and
v. a second base layer adhered to the first fluoropolymer layer via the second intermediate adhesive layer;
b) a top cover adhered to the top surface of the container, the top cover comprising:
i. a first heat seal layer attached to the first base layer;
ii. a third intermediate adhesive layer; and
iii. a second fluoropolymer layer adhered to the first heat seal layer via the third intermediate adhesive layer.

2. The package of claim 1 further comprising a first support layer adhered to the second fluoropolymer layer via a fourth intermediate adhesive layer.

3. The package of claim 1 wherein the package further comprises:
c) a bottom cover adhered to the bottom surface of the container, the bottom cover comprising:
i. a second heat seal layer attached to the second base layer;
ii. a fifth intermediate adhesive layer; and
iii. a third fluoropolymer layer adhered to the second heat seal layer via the fifth intermediate adhesive layer.

4. The package of claim 3 further comprising a first support layer adhered to the second fluoropolymer layer via a fourth intermediate adhesive layer, and a second support layer adhered to the third fluoropolymer layer via a sixth intermediate adhesive layer.

5. The package of claim 4 wherein each fluoropolymer layer comprises a polychlorotrifluoroethylene (PCTFE) homopolymer or copolymer.

6. The package of claim 5 wherein each support layer comprises a polyester, a polyamide, a polyolefin, polycarbonate or acrylonitrile butadiene styrene.

7. The package of claim 6 wherein each intermediate adhesive layer comprises a polyurethane.

8. The package of claim 7 wherein each base layer comprises polystyrene, polycarbonate, acrylonitrile butadiene styrene, or paper.

9. The package of claim 8 wherein each base layer comprises polystyrene.

10. The package of claim 9 wherein each heat seal layer comprises a polyolefin homopolymer or copolymer.

11. The package of claim 10 wherein each heat seal layer comprises polyethylene.

12. A packaged product comprising:
a) a shaped container comprising a multilayer film, the container comprising one or more pockets, said container having a top surface and a bottom surface, the multilayer film comprising:
i. a first base layer;
ii. first intermediate adhesive layer;
iii. a first fluoropolymer layer adhered to the first base layer via the first intermediate adhesive layer;
iv. a second intermediate adhesive layer; and
v. a second base layer adhered to the first fluoropolymer layer via the second intermediate adhesive layer;
b) a product contained within one or more of said pockets;
c) a top cover adhered to the top surface of the container, the top cover comprising:
i. a first heat seal layer attached to the first base layer;
ii. a third intermediate adhesive layer; and
iii. a second fluoropolymer layer adhered to the first heat seal layer via the third intermediate adhesive layer;
and optionally,
d) a bottom cover adhered to the bottom surface of the container, the bottom cover comprising:
i. a second heat seal layer attached to the second base layer;
ii. a fifth intermediate adhesive layer; and
iii. a third fluoropolymer layer adhered to the second heat seal layer via the fifth intermediate adhesive layer.

13. The packaged product of claim 12 wherein the package is a carrier tape comprising a plurality of pockets and wherein a product is contained in one or more of said pockets.

14. The packaged product of claim 13 wherein the bottom cover is present.

15. The packaged product of claim 14 wherein each product comprises a microchip or other electronic device component.

16. A process for forming a carrier tape useful for storing a plurality of products, the process comprising:
a) forming a multilayer film comprising:
i. a first base layer;
ii. first intermediate adhesive layer;
iii. a first fluoropolymer layer adhered to the first base layer via the first intermediate adhesive layer;
iv. a second intermediate adhesive layer; and
v. a second base layer adhered to the first fluoropolymer layer via the second intermediate adhesive layer;
b) embossing the multilayer film to thereby form a shaped container that comprises one or more pockets, said container having a top surface and a bottom surface;
c) placing a product into one or more of said pockets; and
d) heat sealing a top cover to the top surface of the container, which top cover comprises:
i. a first heat seal layer;
ii. a third intermediate adhesive layer; and
iii. a second fluoropolymer layer adhered to the first heat seal layer via the third intermediate adhesive layer;
wherein the first heat seal layer is attached to the first base layer.

17. The process of claim 16 further comprising heat sealing a bottom cover to the bottom surface of the container, which bottom cover comprises:
i. a second heat seal layer;
ii. a fifth intermediate adhesive layer; and
iii. a third fluoropolymer layer adhered to the second heat seal layer via the fifth intermediate adhesive layer;
wherein the second heat seal layer is attached to the second base layer.

18. The process of claim 16 wherein the multilayer film is embossed with a plurality of pockets.

19. The process of claim 17 wherein the multilayer film is embossed with a plurality of pockets.

20. The process of claim 19 wherein each product comprises a microchip or other electronic device component.
